(19) United States
(12) Patent Application Publication
(10) Pub. No.: US 2014/0238867 A1
(43) Pub. Date: Aug. 28, 2014

(54) COATED OVERHEAD CONDUCTORS AND METHODS

(71) Applicant: General Cable Technologies Corporation, Highland Heights, KY (US)

(72) Inventors: Sathish K. RANGANATHAN, Plainfield, IN (US); Vijay MHETAR, (US); Cody R. DAVIS, Maineville, OH (US); Srinivas SIRIPURAPU, Carmel, IN (US)

(73) Assignee: GENERAL CABLETECHNOLOGIES CORPORATION, Highland Heights, KY (US)

(21) Appl. No.: 14/185,429

(22) Filed: Feb. 20, 2014

Related U.S. Application Data
(60) Provisional application No. 61/769,492, filed on Feb. 26, 2013.

(51) Int. Cl. H01B 7/42; C25D 7/06

(52) U.S. Cl. CPC H01B 7/421; C25D 7/0607
USPC 205/250; 205/333; 205/95; 205/323; 205/320; 205/159; 205/162; 205/108

(57) ABSTRACT

A coated overhead conductor having an assembly including one or more conductive wires, such that the assembly includes an outer surface coated with an electrochemical deposition coating forming an outer layer, wherein the electrochemical deposition coating includes a first metal oxide, such that the first metal oxide is not aluminum oxide. Methods for making the overhead conductor are also provided.

### CROSS-REFERENCE TO RELATED APPLICATION

The present application claims priority of U.S. provisional application Ser. No. 61/769,492, filed Feb. 26, 2013, and hereby incorporates the same application herein by reference in its entirety.

### TECHNICAL FIELD

The present disclosure generally relates to a coated overhead conductor which better radiates heat away, thereby reducing operating temperature.

### BACKGROUND

As the need for electricity continues to grow, the need for higher capacity transmission and distribution lines grows as well. The amount of power a transmission line can deliver is dependent on the current-carrying capacity (ampacity) of the line. For a given size of the conductor, the ampacity of the line is limited by the maximum safe operating temperature of the bare conductor that carries the current. Exceeding this temperature can result in damage to the conductor or the accessories of the line. Moreover, the conductor gets heated by Ohmic losses and solar heat and cooled by conduction, convection and radiation. The amount of heat generated due to Ohmic losses depends on current (I) passing through the conductor and its electrical resistance (R) by the relationship—Ohmic losses=I²R. Electrical resistance (R) itself depends on temperature. Higher current and temperature lead to higher electrical resistance, which, in turn, leads to more electrical losses in the conductor.

### SUMMARY

In accordance with one embodiment, a coated overhead conductor includes an assembly including one or more conductive wires. The assembly also includes an outer surface coated with an electrochemical deposition coating forming an outer layer. The electrochemical deposition coating includes a first metal oxide. The first metal oxide is not aluminum oxide.

In accordance with another embodiment, a method of making a coated overhead conductor includes providing a bare conductor and performing electrochemical deposition of a first metal oxide on an outer surface of the bare conductor to form an outer layer on the bare conductor. The outer layer includes an electrochemical deposition coating. The first metal oxide is not aluminum oxide.

In accordance with yet another embodiment, a coated overhead conductor includes an assembly including one or more conductive wires. The one or more conductive wires are formed of aluminum or aluminum alloy. The assembly includes an outer surface coated with an electrochemical deposition coating forming an outer layer. The electrochemical deposition coating includes titanium oxide, zirconium oxide or combinations thereof. The outer layer has a thickness from about 5 microns to about 25 microns.

### BRIEF DESCRIPTION OF THE DRAWINGS

Various embodiments will become better understood with regard to the following description, appended claims and accompanying drawings wherein:

FIG. 1 is a cross-sectional view of an overhead conductor in accordance with one embodiment.

FIG. 2 is a cross-sectional view of an overhead conductor in accordance with another embodiment.

FIG. 3 is a cross-sectional view of an overhead conductor in accordance with yet another embodiment.

FIG. 4 is a cross-sectional view of an overhead conductor in accordance with still another embodiment.

FIG. 5 is a test setup to measure the temperature of coated and uncoated energized aluminum substrates, in accordance with an embodiment.

### DETAILED DESCRIPTION

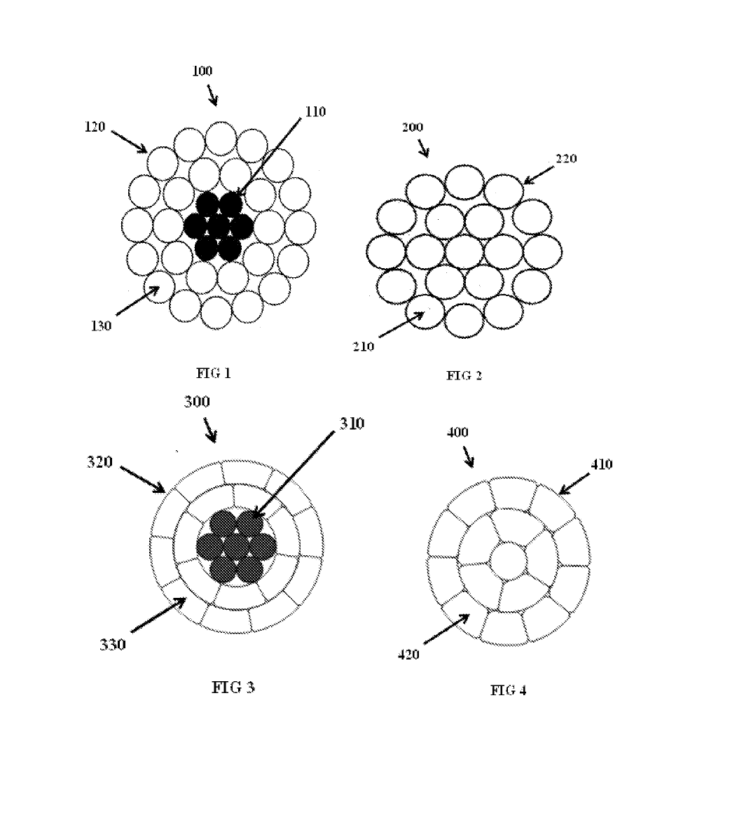

Selected embodiments are hereinafter described in detail in connection with the views and examples of FIGS. 1-5.

Metal oxide coated overhead conductors, when tested in under similar current and ambient conditions, can have a reduced operating temperature by at least 5° C. compared to the temperature of the same conductor without the surface modification.

Accordingly, it can be desirable to provide a modified overhead conductor that operates at significantly lower temperatures compared to an unmodified overhead conductor that operates under the same operating conditions, such as current and ambient conditions. Such a modified overhead conductor can have a coating of metal oxide other than aluminum oxide, such that when tested under similar current and ambient conditions, has a reduced operating temperature by at least 5° C. compared to the operating temperature of the same conductor without the coating. At higher operating temperatures, e.g. above 100° C., a coated conductor can have a reduction of at least 10° C. when compared to an uncoated conductor when tested under similar current and ambient conditions (e.g., operating conditions).

Overhead conductors can be coated using a variety of techniques; however, one advantageous method includes coating the overhead conductor via electrochemical deposition with a metal oxide on the surface of the overhead conductor. The method can contain the steps of:
a) Pretreatment: cleaning and preparing the surface of the overhead conductor;
b) Coating: coating the surface of overhead conductor with metal oxide coating using electrochemical deposition;
c) Rinsing (optional); and
d) Drying: drying the coated overhead conductor in air or in an oven.

Suitable pre-treatment for a surface of an overhead conductor can include hot water cleaning, ultrasonic, de-glaring, sandblasting, chemicals (like alkaline or acidic), and others or a combination of the above methods. The pre-treatment process can be used to remove dirt, dust, and oil for preparing the surface of the overhead conductor for electrochemical deposition.

The overhead conductor can be made of conductive wires of metal or metal alloy. Examples include copper and aluminum and the respective alloys. Aluminum and its alloys are advantageous for an overhead conductor due to their lighter weight.

Electrochemical deposition of a metal oxide is one method for coating the surface of an overhead conductor. Electrochemical coating compositions using an electrochemical deposition process can include, for example, those found in U.S. Pat. Nos. 8,361,630, 7,820,300, 6,797,147 and 6,916,414; U.S. Patent Application Publication Nos. 2010/0252241, 2008/0210567, 2007/0148479; and WO 2006/136335A1; which are each incorporated herein by reference in their entirety.

One method for forming a metal oxide coated aluminum overhead conductor can include the steps of: providing an anodizing solution comprising an aqueous water soluble complex of fluoride and/or oxyfluoride of a metal ion selected from one or more of titanium, zirconium, zinc, vanadium, hafnium, tin, germanium, niobium, nickel, magnesium, berrilium, cerium, gallium, iron, yttrium and boron, placing a cathode in the anodizing solution, placing the surface of the overhead conductor as an anode in the anodizing solution, applying a current across the cathode and the anode through the anodizing solution for a period of time effective to coat the aluminum surface, at least partially, with a metal oxide on the surface of the surface of the conductor to form a coating. Such coatings having a metal oxide can include a ceramic coating.

In one embodiment, electrochemical deposition of the coating includes maintaining an anodizing solution at a temperature between 0° C. and 90° C.; immersing at least a portion of the surface of the overhead conductor in the anodizing solution; and applying a voltage to the overhead conductor. The anodizing solution can be contained within a bath or a tank.

The current passed through a cathode, anode and anodizing solution can include pulsed direct current, non-pulsed direct current and/or alternating current. When using pulsed current, an average voltage potential can generally be not in excess of 600 volts. When using direct current (DC), suitable range is 10 to 400 Amps/square foot and 150 to 600 volts. In a certain embodiment, the current is pulsed with an average voltage of the pulsed direct current is in a range of 150 to 600 volts; in a certain embodiment in a range of 250 to 500 volts; in a certain embodiment in a range of 450 volts. Non-pulsed direct current is desirably used in the range of 200-600 volts.

A number of different types of anodizing solutions can be used. For example, a wide variety of water-soluble or water-dispersible anionic species containing metal, metalloid, and/or non-metal elements are suitable for use as components of the anodizing solution. Representative elements can include, for example, titanium, zirconium, zinc, vanadium, hafnium, tin, germanium, niobium, nickel, magnesium, berrilium, cerium, gallium, iron, yttrium and boron and the like (including combinations of such elements). In certain embodiments, components of the anodizing solution are titanium and/or zirconium.

In one embodiment, the anodizing solution can contain water and at least one complex fluoride or oxyfluoride of an element selected from the group consisting of titanium, zirconium, zinc, vanadium, hafnium, tin, germanium, niobium, nickel, magnesium, berrilium, cerium, gallium, iron, yttrium and boron. In certain embodiments such elements are titanium and/or zirconium. In certain embodiments, the coating can further contain IR reflective pigments.

In another embodiment, a method for making an overhead conductor can include providing of a metal oxide coating. The method can include providing an anodizing solution containing water, a phosphorus containing acid and/or salt, and one or more additional components selected from the group consisting of: water-soluble complex fluorides, water-soluble complex oxyfluorides, water-dispersible complex fluorides, and water-dispersible complex oxyfluorides of elements selected from the group consisting of titanium and zirconium, placing a cathode in the anodizing solution, placing the overhead conductor having a surface of an aluminum or aluminum alloy as an anode in the anodizing solution, passing a pulsed current across the cathode and the anode through the anodizing solution for a period of time effective to form a titanium oxide or zirconium oxide coating on at least a surface of the overhead conductor.

Electrochemical deposition of a metal oxide coating can be achieved either directly on the finished conductor or coating individual conductive wires separately before stranding the coated individual wires to make the overhead conductor. In certain embodiments, it is possible to have all of the wires of the conductor surface coated, or more economically, via another embodiment, only having the outer most wires of the conductor surface coated. In another embodiment, the electrochemical deposition coating can be applied only to the outer surface of the overhead conductor. Here, the conductor itself is stranded and made into final form before electrochemical deposition. Electrochemical deposition can be done by batch process, semi-continuous process, continuous process, or combinations of these processes.

FIGS. 1, 2, 3, and 4 illustrate various bare overhead conductors according to various embodiments incorporating a coated surface.

As seen in FIG. 1, an overhead conductor 100 generally includes a core 110 of one or more wires, round conductive wires 130 around the core 110, and a coating layer 120. The core 110 can be formed from any of a variety of suitable materials including, for example, steel, invar steel, carbon fiber composite, or any other material providing strength to the conductor 100. The conductive wires 130 can be made from a conductive material, such as copper, copper alloy, aluminum, or aluminum alloy. Such aluminum alloys can include aluminum types 1350, 6000 series alloy aluminum, or aluminum-zirconium alloy, for example.

As seen in FIG. 2, an overhead conductor 200 can generally include round conductive wires 210 and a coating layer 220. Again, in certain embodiments, the conductive wires 210 can be made from a conductive material, such as copper, copper alloy, aluminum, or aluminum alloy. Such aluminum alloys can include aluminum types 1350, 6000 series alloy aluminum, or aluminum-zirconium alloy, for example.

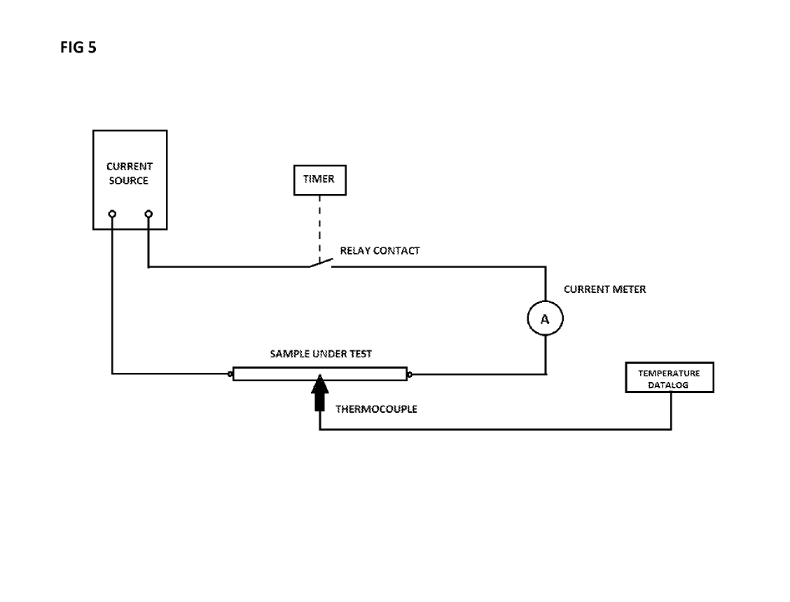

As seen in FIG. 3, an overhead conductor 300 can generally include a core 310 of one or more wires, trapezoidal shaped conductive wires 330 around the core 310, and a coating layer 320. The core 310 can be formed from any of a variety of suitable materials including, for example, steel (e.g. invar steel), aluminum alloy (e.g. 600 series aluminum alloy), carbon fiber composite, glass fiber composite, carbon nanotube composite, or any other material providing strength to the overhead conductor 300. Again, in certain embodiments, the conductive wires 330 can be made from a conductive material, such as copper, copper alloy, aluminum, or aluminum alloy. Such aluminum alloys can include aluminum types 1350, 6000 series alloy aluminum, or aluminum-zirconium alloy, for example.

As seen in FIG. 4, an overhead conductor 400 is generally shown to include trapezoidal-shaped conductive wires 420 and a coating layer 410. Again, in certain embodiments, the conductive wires 420 can be made from a conductive material, such as copper, copper alloy, aluminum, or aluminum alloy. Such aluminum alloys can include aluminum types 1350, 6000 series alloy aluminum, or aluminum-zirconium alloy, for example.

Composite core conductors can beneficially provide lower sag at higher operating temperatures and higher strength to weight ratio. Reduced conductor operating temperatures due to surface modification can further lower sag of the conductors and lower degradation of polymer resin in the composite core.

The surface modification described herein can also be applied in association with conductor accessories and overhead conductor electrical transmission related products and parts, for the purpose of achieving temperature reduction. Examples include deadends/termination products, splices/joints products, suspension and support products, motion control/vibration products (also called dampers), guying products, wildlife protection and deterrent products, conductor and compression fitting repair parts, substation products, clamps and other transmission and distribution accessories. Such products are commercially available from a number of manufacturers such as Preformed Line Products (PLP), Cleveland, Ohio, and AFL, Duncan, S.C.

The electrochemical deposition coating can have a desired thickness on the surface of the overhead conductor. In certain embodiments, this thickness can be from about 1 micron to about 100 microns; in certain embodiments from about 1 micron to about 25 microns; and in certain embodiments, from about 5 microns to about 20 microns. The thickness of the coating can be surprisingly even along the conductor. For example, in certain embodiments, the thickness can have a variation of about 3 microns or less; in certain embodiments, of about 2 microns or less; and in certain embodiments, of about 1 micron or less. Such electrochemical deposition coatings as described herein can be non-white in color. In certain embodiments, the color of the electrochemical deposition coatings can range in color from blue-grey and light grey to charcoal grey depending upon the coating thickness and relative amounts of metal oxides, such as titanium oxide and/or zinc oxide. In certain embodiments, such coatings can also be electrically non-conductive. As used herein, “electrically non-conductive” means volume resistivity greater than or equal to 1×10⁴ ohm-cm.

Without further description, it is believed that one of ordinary skill in the art can, using the preceding description and the following illustrative examples, make and utilize the coatings and overhead conductors as described herein and practice the claimed methods. The following examples are given to further illustrate the claimed invention. It should be understood that the claimed invention is not to be limited to the specific conditions or details described in the cited examples.

### Experimental Set-Up to Measure Effect of Coating on Operating Temperature of Conductor

An experimental set-up to measure the effectiveness of an electrochemical deposition coating to reduce operating temperature of a conductor is prepared as described below. A current is applied through coated and uncoated samples. The coated sample can be a metal oxide coated aluminum or aluminum alloy substrate. The uncoated sample can be a similar aluminum or aluminum alloy substrate, but uncoated. The test apparatus is shown in FIG. 5 and mainly includes a 60 Hz AC current source, a true RMS clamp-on current meter, a temperature datalog recording device, and a timer. Testing was conducted within a 68″ wide×33″ deep windowed safety enclosure to control air movement around the sample. An exhaust hood was located 64″ above the test apparatus for ventilation.

The sample to be tested was connected in series with the AC current source through a relay contact controlled by the timer. The timer was used to control the time duration of the test. The 60 Hz AC current flowing through the sample was monitored by the true RMS clamp-on current meter. A thermocouple was used to measure the surface temperature of the sample. Using a spring clamp, the tip of the thermocouple was kept firmly in contact with the center surface of the sample. The thermocouple was monitored by the temperature datalog recording device to provide a continuous record of temperature.

Both uncoated and coated substrate samples were tested for temperature rise on this experimental set-up under identical conditions. The current was set at a desired level and was monitored during the test to ensure that a constant current was flowing through the samples. The timer was set at a desired value; and the temperature datalog recording device was set to record temperature at a recording interval of one reading per second.

The metal component for the uncoated and coated samples was from the same source material and lot of Aluminum 1350. The finished dimensions of the uncoated sample was 12.0″(L)×0.50″(W)×0.027″(T). The finished dimensions of the coated sample was 12.0″(L)×0.50″(W)×0.028″(T). The increase in thickness was due to the thickness of the applied coating.

The uncoated sample was firmly placed into the test set-up and the thermocouple secured to the center portion of the sample. Once this was completed, the current source was switched on and was adjusted to the required ampacity load level. Once this was achieved the power was switched off. For the test itself, once the timer and the temperature datalog recording device were all properly set, the timer was turned on to activate the current source starting the test. The desired current flowed through the sample and the temperature started rising. The surface temperature change of the sample was automatically recorded by the temperature datalog recording device. Once the testing period was completed, the timer automatically shut down the current source ending the test.

Once the uncoated sample was tested, it was removed from the set-up and replaced by the coated sample. The testing resumed making no adjustments to the AC current source. The same current level was passed through the uncoated and coated samples.

The temperature test data was then accessed from the temperature datalog recording device and analyzed using a computer. Comparing the results from the uncoated sample test with that from the coated test was used to determine the comparative emissivity effectiveness of the coating material.

### Methodology to Measure Flexibility and Thermal Stability of Coating

To study thermal stability of an electrochemical deposition coating, coated samples were places in air circulation oven at a temperature of 325° C. for a period of 1 day and 7 days. After the thermal aging was complete, the samples were placed at room temperature for a period of 24 hrs. The samples were then bent on different cylindrical mandrels sized from larger diameter to smaller diameter and the coatings were observed for any visible cracks at each of the mandrel sizes. Results were compared with the flexibility of the coating prior to thermal aging.

### EXAMPLES

### Comparative Example 1

Uncoated strips of aluminum (ASTM grade 1350; Dimensions: 12.0″(L)×0.50″(W)×0.028″(T)) were tested for operating temperature as per the test method described above. The test set up is illustrated in FIG. 5.

### Inventive Example 1

The same strips of aluminum described in Comparative Example 1 were coated with an electrochemical deposition coating of titanium oxide (commercially available as Alodine EC2 from Henkel Corporation). The sample dimensions prior to coating were 12.0″(L)×0.50″(W)×0.028″(T). The thickness of the coating was 12-15 microns. The sample was then tested for reduction in operating temperature by the test method described above. The titanium oxide coated sample was found to demonstrate significantly lower operating temperature compared to the uncoated sample (Comparative Example 1), as summarized in Table 1 below.

TABLE 1
Operating temperature reduction data for coated & uncoated sample

| | Comparative | Inventive |
|---|---|---|
| | Example 1 | Example 1 |
| Substrate | Aluminum 1350 | Aluminum 1350 |
| Coating | None | Titanium Oxide |
| Conductor Temperature at 95 Amp | 127 | 103 |
| current (° C.) | | |

### Comparative Example 2

The same strips of aluminum described in Comparative Example 1 were anodized. The anodized layer thickness was 8-10 microns. The flexibility of the anodized coating was tested by performing the mandrel bend test as described above. The flexibility test was also conducted after thermal aging at 325° C. for 1 day and 7 days.

### Comparative Example 3

The same strips of aluminum described in Comparative Example 1 were coated with a coating containing 40% sodium silicate solution in water (75% by weight) and zinc oxide (25% by weight) by brush application. The coating thickness was about 20 microns. Flexibility of the coating was tested by performing the mandrel bend test as described above. The flexibility test was also conducted after thermal aging at 325° C. for 1 day and 7 days.

The flexibility test data is summarized in Table 2 below. The sample with the electrochemically deposited titanium oxide coating showed significantly better flexibility compared to each of the anodized coating and the sodium silicate with ZnO brush coating. Moreover there was no change in the flexibility of the titanium oxide coating with thermal aging at 325° C. for 1 and 7 days.

TABLE 2
Flexibility and thermal stability data for differently coated samples

| | Comparative | Comparative | Inventive |
|---|---|---|---|
| | Example 2 | Example 3 | Example 1 |
| Substrate | Aluminum 1350 | Aluminum 1350 | Aluminum 1350 |
| Coating | Anodized | Sodium silicate + | Titanium Oxide |
| | | Zinc Oxide | |
| Application of | Anodized | Brushed | Electrochemical |
| Coating | | | Deposition |
| Before ageing | 8″ mandrel | 4″ mandrel | 1″ mandrel |
| (Initial) | Cracks observed | Cracks | Pass - no cracks |
| | | observed | observed |
| After heat | 8″ mandrel | 4″ mandrel | 1″ mandrel |
| ageing at | Cracks observed | Cracks | Pass - no cracks |
| 325° C. for | | observed | observed |
| 1 day | | | |
| After heat | 8″ mandrel | 4″ mandrel | 1″ mandrel |
| ageing at | Cracks observed | Cracks | Pass - no cracks |
| 325° C. for | | observed | observed |
| 7 days | | | |

While particular embodiments have been chosen to illustrate the claimed invention, it will be understood by those skilled in the art that various changes and modifications can be made therein without departing from the scope of the claimed invention as defined in the appended claims.

What is claimed is:

1. A coated overhead conductor comprising an assembly including one or more conductive wires, wherein the assembly comprises an outer surface coated with an electrochemical deposition coating forming an outer layer, wherein the electrochemical deposition coating comprises a first metal oxide, wherein the first metal oxide is not aluminum oxide.

2. The coated overhead conductor of claim 1, wherein the first metal oxide comprises titanium oxide, zirconium oxide, zinc oxide, niobium oxide, vanadium oxide, molybdenum oxide, copper oxide, nickel oxide, magnesium oxide, beryllium oxide, cerium oxide, boron oxide, gallium oxide, hafnium oxide, tin oxide, iron oxide, yttrium oxide or combinations thereof.

3. The coated overhead conductor of claim 1, wherein the one or more conductive wires are formed of aluminum or aluminum alloy.

4. The coated overhead conductor of claim 3, wherein the outer layer is further formed of a second metal oxide, wherein the second metal oxide is aluminum oxide.

5. The coated overhead conductor of claim 1, wherein the one or more conductive wires are formed of copper or copper alloy.

6. The coated overhead conductor of claim 2, wherein the first metal oxide comprises titanium oxide, zirconium oxide or combinations thereof.

7. The coated overhead conductor of claim 1 having a lower operating temperature compared to the operating temperature of an uncoated overhead conductor at similar operating conditions.

8. The coated overhead conductor of claim 1, wherein the electrochemical deposition coating is non-white.

9. The coated overhead conductor of claim 1, wherein the outer layer has a thickness of about 1 micron or more.

10. The coated overhead conductor of claim 1, wherein the outer layer has a thickness of about 5 microns to about 25 microns.

11. The coated overhead conductor of claim 1, wherein the outer layer has a thickness variation of about 3 microns or less.

12. The coated overhead conductor of claim 1 having an operating temperature reduced by at least 5° C. when compared to the operating temperature of an uncoated overhead conductor at similar operating conditions.

13. The coated overhead conductor of claim 1 having an operating temperature reduced by at least 10° C. when compared to the operating temperature of an uncoated overhead conductor, when the operating temperatures measured are above 100° C. and at similar operating conditions.

14. The coated overhead conductor of claim 1 having reduced power transmission loss when compared to an uncoated overhead conductor at similar operating conditions.

15. The coated overhead conductor of claim 1 having increased current carrying capacity when compared to an uncoated overhead conductor at similar operating conditions.

16. The coated overhead conductor of claim 3, wherein the one or more conductive wires are formed from an aluminum alloy selected from the group consisting of 1350 alloy aluminum, 6000-series alloy aluminum, aluminum-zirconium alloy, and combinations thereof.

17. The coated overhead conductor of claim 1, wherein at least some of the one or more conductive wires have trapezoidal cross-sections.

18. The coated overhead conductor of claim 1, wherein the one or more conductive wires surround a core comprised of steel, carbon fiber composite, glass fiber composite, carbon nanotube composite, or aluminum alloy.

19. The coated overhead conductor of claim 1, wherein each of the conductive wires is individually coated with the electrochemical deposition coating.

20. The coated overhead conductor of claim 1, wherein a portion of each of the conductive wires is coated with the electrochemical deposition coating.

21. The coated overhead conductor of claim 1, wherein the electrochemical deposition coating is electrically non-conductive.

22. A method for making a coated overhead conductor, the method comprising:
a. providing a bare conductor; and
b. performing electrochemical deposition of a first metal oxide on an outer surface of the bare conductor to form an outer layer on the bare conductor, the outer layer comprising an electrochemical deposition coating, wherein the first metal oxide is not aluminum oxide.

23. The method of claim 22, wherein the electrochemical deposition coating is non-white.

24. The method of claim 22, wherein the first metal oxide is titanium oxide, zirconium oxide, zinc oxide, niobium oxide, vanadium oxide, molybdenum oxide, copper oxide, brass oxide, nickel oxide, magnesium oxide, beryllium oxide, cerium oxide, boron oxide, gallium oxide, hafnium oxide, tin oxide, iron oxide, yttrium oxide, or combinations thereof.

25. The method of claim 22, wherein the outer layer has a thickness of about 1 micron to about 25 microns.

26. The method of claim 22, wherein the outer layer has a thickness variation of about 3 microns or less.

27. The method of claim 22, wherein the coated overhead conductor has an operating temperature reduced by at least 5° C. compared to the operating temperature of an uncoated overhead conductor at similar operating conditions.

28. The method of claim 22, wherein the coated overhead conductor has an operating temperature reduced by at least 10° C. compared to the operating temperature of an uncoated overhead conductor, when the operating temperatures is above 100° C. at similar operating conditions.

29. The method of claim 22, wherein the coated overhead conductor has reduced power transmission loss when compared to an uncoated overhead conductor at similar operating conditions.

30. The method of claim 22, wherein the coated overhead conductor has increased current carrying capacity when compared to an uncoated overhead conductor at similar operating conditions.

31. The method of claim 22, wherein the bare conductor comprises a plurality of conductor wires made from one or more of copper, copper alloy, aluminum, or aluminum alloy.

32. The method of claim 31, wherein the plurality of conductive wires are formed from an aluminum alloy comprising 1350 alloy aluminum, 6000-series alloy aluminum, or aluminum-zirconium alloy.

33. The method of claim 22, wherein the bare conductor comprises a plurality of conductive wires, wherein at least some of the plurality of conductive wires have a trapezoidal cross-section.

34. The method of claim 22, wherein the bare conductor comprises a plurality of conductive wires stranded around a core, and wherein the core is comprises steel, carbon fiber composite, glass fiber composite, carbon nanotube composite, or aluminum alloy.

35. The method of claim 22, wherein the bare conductor is formed of a plurality of conductive wires, and wherein the electrochemical deposition coats only an outer surface of the bare conductor.

36. The method of claim 22, wherein the bare conductor comprises a plurality of conductive wires, and wherein the electrochemical deposition coats each of the conductive wires.

37. The method of claim 22, wherein the electrochemical deposition coats only a portion of the bare conductor.

38. The method of claim 22, wherein the electrochemical deposition coating is electrically non-conductive.

39. The method of claim 22 being continuous, semi-continuous, or batch.

40. The method of claim 22, wherein the performance of the electrochemical deposition comprises:
i. providing an aqueous solution containing at least one of water-soluble complex metal fluorides, water-dispersible complex metal fluorides, water-soluble complex metal oxyfluorides, and water-dispersible metal oxyfluorides;
ii. providing a cathode in contact with said aqueous solution;
iii. placing the bare conductor in the aqueous solution as an anode;
iv. passing a current between the anode and the cathode through the aqueous solution to form the electrochemical deposition coating on the outer surface of the bare conductor; and
v. removing the coated overhead conductor from the aqueous solution.

41. The method of claim 40, wherein the current is pulsed.

42. The method of claim 40, wherein the current is from about 10 amps/square foot to about 400 amps/square foot.

43. The method of claim 40, wherein the metal is titanium or zirconium.

44. The method of claim 22, wherein the metal oxide is titanium oxide or zirconium oxide.

45. A coated overhead conductor comprising an assembly including one or more conductive wires, wherein the one or more conductive wires are formed of aluminum or aluminum alloy, wherein the assembly comprises an outer surface coated with an electrochemical deposition coating forming an outer layer, the electrochemical deposition coating comprises titanium oxide, zirconium oxide or combinations thereof, and the outer layer has a thickness from about 5 microns to about 25 microns.
